(19) United States
(12) Patent Application Publication
(10) Pub. No.: US 2026/0315186 A1
(43) Pub. Date: Oct. 15, 2026

(54) ENDODONTIC INSTRUMENT COMPRISING AN IMPROVED ASSEMBLY PORTION

(71) Applicant: NEOLIX, EVRON (FR)

(72) Inventors: Jacques PERNOT, VIEILLEY (FR); Emilien PAUL, MEZANGERS (FR)

(21) Appl. No.: 19/109,364

(22) PCT Filed: Jul. 26, 2023
(86) PCT No.: PCT/EP2023/070704

§ 371 Date: Mar. 6, 2025

(30) Foreign Application Priority Data
Sep. 8, 2022 (FR) FR2208998

(51) Int. Cl. A61C 5/42

(52) U.S. Cl. CPC A61C 5/42

(57) ABSTRACT

An endodontic instrument having an active portion which extends from the free end thereof, and an assembly portion which extends from the assembly end thereof, wherein the assembly portion has a locking segment, at which three flattened portions are formed on the instrument, each of these three flattened portions being respectively complementary, in each of the cross-sections of the locking segment, to one of the sides of an equilateral triangle centered on the longitudinal axis of the instrument, at least one of the flattened portions being terminated, at the end thereof closest to the assembly end of the instrument, by a shoulder that is oriented substantially toward the free end of the endodontic instrument.

### CROSS-REFERENCES TO RELATED APPLICATIONS

This application is a national phase of International Application Number PCT/EP2023/070704 filed on Jul. 26, 2023, which claims the benefit of French Patent Application No. FR2208998 filed on Sep. 8, 2022, the entire disclosures of which are incorporated herein by way of reference.

### FIELD OF THE INVENTION

The present invention relates to endodontic instruments.

In particular, the invention relates to the assembly portion of such endodontic instruments, allowing the endodontic instrument to be held, and most often rotated, by an instrument-holding equipment.

### BACKGROUND OF THE INVENTION

Among these dental instruments, endodontic instruments are specifically designed to be introduced into the root canals of teeth to perform endodontic treatment. Due to their specific use, endodontic instruments are subject to very different operating constraints to other rotating dental instruments, such as burs. Thus, unlike burs, endodontic instruments rotate at a relatively slow speed, but must transmit a relatively high, precisely controlled torque. These endodontic instruments are generally held in place by specific instrument-holding equipment, which usually allows them to be rotated about their axis.

To allow these endodontic instruments to be effectively held and rotated by the instrument-holding equipment, the instruments are generally fitted with a specific “Type 1” handle standardized by ISO-1797.

This standardized handle has a generally cylindrical shape with a diameter of 2.35 mm, far greater than the diameter of the metal bars from which the blades of endodontic instruments are machined, which is generally between 0.8 mm and 1.2 mm. Centering of the endodontic instrument fitted with such a handle in an instrument-holding equipment is generally ensured by cooperation of the cylindrical shape of the handle with a complementary shape in the instrument-holding equipment. This standardized handle also comprises a plurality of machining operations. Thus, it has a peripheral groove, into which a locking element of the instrument-holding equipment can be inserted, to ensure that the endodontic instrument is locked in the instrument-holding equipment in the axial direction. In addition, the handle also has a flattened portion which, cooperating with a complementary shape of a rotating element of the instrument-holding equipment, allows the endodontic instrument to be rotated.

The centering of the endodontic instrument, its locking in the axial direction and its rotation are therefore each ensured by a specific area of the handle.

Such handles are generally satisfactory for driving endodontic instruments. However, their size is large compared to endodontic instruments, which require a large instrument holder head. The volume of such an instrument holder head can be a disadvantage, as it can block the view of the dentist operating on a patient and create an uncomfortable obstruction in the patient's mouth.

It should also be noted that such a standardized handle can only be inserted into an instrument-holding equipment in a single angular position, corresponding to the alignment of the flattened portion with the complementary shape of the instrument holder. The person carrying out this insertion must therefore feel around, turning the instrument, until they find the angular position that allows the instrument to be locked in the instrument-holding equipment.

Moreover, the manufacture of such standardized handles, as well as their assembly to the handle, are costly operations which substantially increase the production cost of endodontic instruments. In this respect, it should be noted that such standardized handles have a housing to receive the shank of the endodontic instrument blade, which must have the same diameter as this shank. To manufacture a plurality of endodontic instruments from blades of different diameters, it is therefore necessary to have a specific handle reference for each blade diameter.

It has been proposed, especially in FR 2 972 918 A, to produce endodontic instruments with a different, smaller handle, and instrument-holding equipment specifically adapted to such a handle. However, this solution has its disadvantages. As a result, it is difficult to machine, in this small-sized handle, the shapes that allow, on the one hand, the centering and rotation of the handle and, on the other hand, the locking of the position of the instrument in an axial direction.

In addition, the specific instrument holder, which must comprise, on the one hand, a means of centering and rotating the instrument and, on the other hand, a means of locking this instrument in an axial direction, is also complex and difficult to realize, due to the reduced dimensions of the handle.

### SUMMARY OF THE INVENTION

The present invention aims to overcome these disadvantages of the prior art.

In particular, the object of the invention is especially to provide an endodontic instrument comprising an assembly portion of smaller dimensions than the standardized handles normally used.

Another object of the invention is to provide such an endodontic instrument that is easy and inexpensive to manufacture.

Yet another object of the invention is to provide such an endodontic instrument that can be held by instrument-holding equipment of limited complexity.

These objectives, and others which will become clearer later, are achieved using an endodontic instrument extending along a longitudinal axis between a first assembly end and a second free end, this endodontic instrument having an active portion which extends from its free end, and an assembly portion which extends from its assembly end, wherein the assembly portion has a locking segment, at which three flattened portions are formed on the instrument, each of these three flattened portions being respectively complementary, in each of the cross-sections of the locking segment, to one of the sides of an equilateral triangle centered on the longitudinal axis, at least one of these flattened portions being terminated, at the end thereof closest to the assembly end of the instrument, by a shoulder oriented substantially toward the free end of the endodontic instrument.

Such a shape of the assembly portion of the endodontic instrument ensures effective centering, holding and rotation of the endodontic instrument, even when this assembly portion has small dimensions, less than those of the standardized handles often used for endodontic instruments.

It is particularly advantageous, on such an assembly portion, that the functions of centering, transmitting rotation and translationally locking along the longitudinal axis, at least in the direction corresponding to withdrawal of the instrument, are ensured by the same flattened portions. Such a configuration simplifies the manufacture of the assembly portion. It also makes it possible to reduce the dimensions of this assembly portion, and especially its length, which is particularly advantageous for reducing the space taken up by endodontic devices in patients' mouths.

Furthermore, such an instrument can equally be locked in any of three angular positions in an instrument holder. Therefore, its insertion into the instrument holder is easier than the insertion of prior art endodontic instruments having a standardized handle, which can only be locked in a single angular position.

Finally, the inventors have verified that flattened portions compatible with the same instrument-holding equipment can be effectively implemented on a range of different endodontic instruments with different diameters.

Advantageously, the endodontic instrument is formed by machining a cylindrical rod the axis of symmetry of which constitutes the longitudinal axis of the instrument.

Such an endodontic instrument, which does not require the assembly of a handle attached to the blade, but is formed integrally by the same machined cylindrical rod, can be manufactured more easily than the endodontic instruments normally used.

According to a particular embodiment, each of the flattened portions is terminated, at the end thereof closest to the free end of the instrument, by a shoulder oriented substantially toward the assembly end of the instrument.

In this embodiment, the flattened portions can translationally lock the instrument in the direction of its assembly end. In other cases, it is also possible for this locking to be ensured by contact of this assembly end with an element of the instrument-holding equipment.

Preferably, each of the flattened portions forms a flat surface. Preferably, the surface of each of the flattened portions is substantially parallel to the longitudinal axis.

Such machining operations are very easy to perform. However, other shapes of flattened portions can provide the same instrument-holding characteristics, provided that the instrument-holding equipment is suitable.

In a particularly advantageous embodiment, each of the flattened portions is located at a distance from the longitudinal axis of between 0.25 mm and 0.35 mm, and the endodontic instrument is formed by machining a cylindrical rod the diameter of which is between 0.8 mm and 1.2 mm.

It is thus possible to supply a range of endodontic instruments, covering all the usual needs of endodontics, which have identical flattened portions and can therefore be effectively held by the same instrument-holding equipment.

According to an advantageous embodiment, the assembly portion has an end segment between the assembly end and the locking segment, the end segment having three flattened portions, respectively parallel to the three flattened portions of the locking segment, and located at a greater distance from the longitudinal axis than the flattened portions of the locking segment.

Such an end segment shape can facilitate the insertion of the assembly portion into an instrument-holding equipment, especially when the dimensions of the rod in which the instrument is machined are large.

### BRIEF DESCRIPTION OF THE DRAWINGS

The invention will be better understood upon reading the following description of preferential embodiments, given by way of a simple figurative, non-limiting example, and accompanied by the figures, in which:

FIG. 1 is a schematic side view of an endodontic instrument 1 according to one embodiment of the invention.

FIG. 2 is a cross-sectional view of the endodontic instrument shown in FIG. 1.

FIG. 3 is a schematic perspective view of an endodontic instrument 2 according to another embodiment of the invention.

FIG. 4 is a cross-sectional view of the endodontic instrument shown in FIG. 3.

FIG. 5 is a schematic perspective view of an endodontic instrument 3 according to another embodiment of the invention.

FIG. 6 is a cross-sectional view of the endodontic instrument shown in FIG. 5.

FIG. 7 is a schematic perspective view of an endodontic instrument 4 according to another embodiment of the invention.

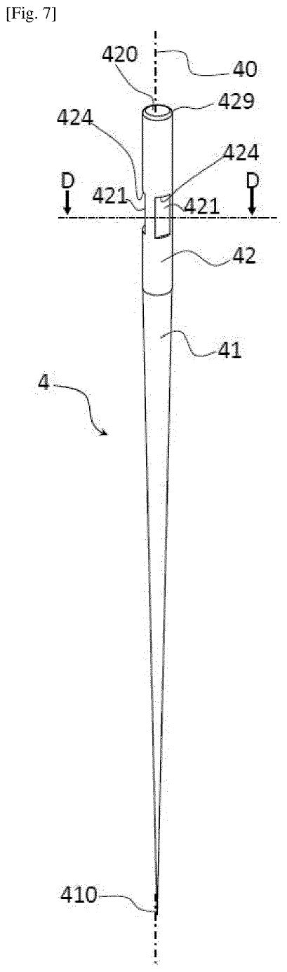

FIG. 8 is a cross-sectional view of the endodontic instrument shown in FIG. 7.

### DETAILED DESCRIPTION OF THE PREFERRED EMBODIMENTS

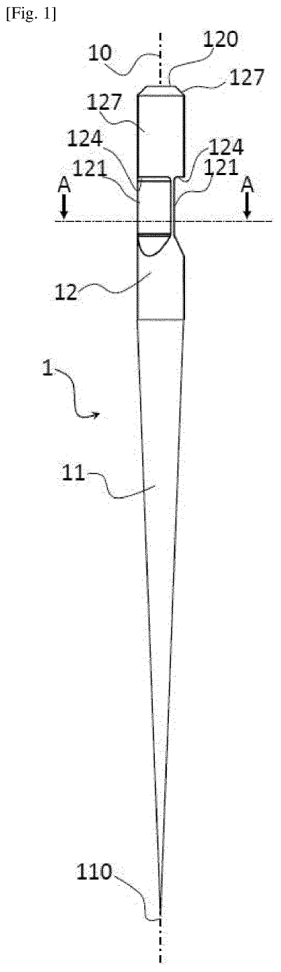

FIG. 1 is a schematic side view of an endodontic instrument 1 according to one embodiment of the invention. This endodontic instrument 1 is manufactured by machining a cylindrical metal bar, the axis of symmetry of which constitutes the longitudinal axis 10 of the endodontic instrument 1. In the remainder of the description, the term “transverse plane” relates to a plane perpendicular to this longitudinal axis.

The endodontic instrument 1 extends along this longitudinal axis 10 between its two ends, respectively consisting of a free end, or tip 110, and an assembly end 120. Between these two ends, the endodontic instrument 1 consists of a plurality of portions, each forming a segment of the instrument.

Thus, an active portion 11 extending from the tip 110 of the instrument occupies a significant part of the length of the endodontic instrument 1. This active portion 11, which is generally machined to have cutting or abrasive surfaces, is intended to be introduced into the root canal of a tooth for treatment. In FIG. 1, as in the other figures of this application, it is represented schematically by a conical portion.

The endodontic instrument 1 also has an assembly portion 12, which is intended to be inserted into an instrument-holding equipment to ensure that the endodontic instrument 1 is held by the instrument-holding equipment.

The active portion 11 and the assembly portion 12 can together constitute the entire length of the endodontic instrument 1. In some embodiments, an intermediate portion of the endodontic instrument 1 may also be provided between the active portion 11 and the assembly portion 12.

In the embodiment shown, the assembly portion 12 is largely formed by the cylindrical surface of the cylindrical metal bar used to manufacture the endodontic instrument 1. Some parts of the surface of the assembly portion 12 are, however, formed by machining this cylindrical metal bar.

Thus, the segment of the assembly portion 12 immediately adjacent to the assembly end 120 has a chamfer 129, which advantageously facilitates the insertion of the assembly portion 12 into an instrument holder head. In the embodiment shown in FIG. 1, this chamfer has a conical shape, which can be produced by turning, for example.

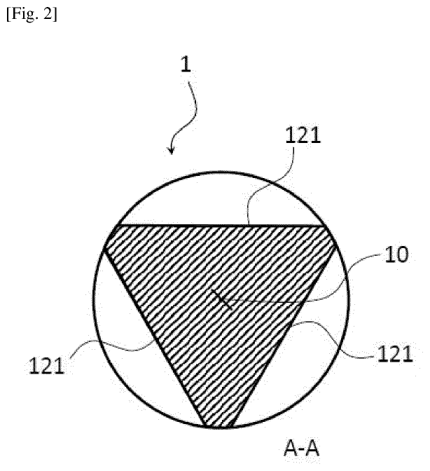

In addition, three flattened portions 121 are machined into the assembly portion 12 of the endodontic instrument 1. For the purposes of the present invention, a “flattened portion” is defined as a surface that appears straight in a plane transverse to the longitudinal axis 10 of the endodontic instrument 1. These three flattened portions 121 are clearly visible in FIG. 2, which is a cross-sectional view of the endodontic instrument 1 at these flattened portions 121.

These three flattened portions 121 are located on the same section of the assembly portion 12, hereinafter referred to as the locking segment. As shown in FIG. 2, they are positioned such that, in a plane transverse to the longitudinal axis 10, the three flattened portions 121 are respectively complementary to the shape of the three sides of an equilateral triangle centered on the longitudinal axis 10.

The flattened portions 121 are advantageously closer to the longitudinal axis 10 of the endodontic instrument 1 than the surfaces of the end segment 127 of the assembly portion 12 which is located between the flattened portions and the assembly end 120, such that shoulders 124 appear at the junction between the flattened portions 121 and the end segment 127. The ends of these flattened portions 121, which are closest to the assembly end of the instrument, are therefore delimited by these shoulders oriented toward the tip 110. Thus, the three shoulders 124, respectively delimiting the ends of the flattened portions 121, are advantageously located at equal distance from the assembly end 120 of the endodontic instrument 1 and are therefore located substantially in the same transverse plane of this endodontic instrument 1.

These shoulders can be flat surfaces located in a transverse plane, the normals of which, parallel to the longitudinal axis, are oriented in the direction of the tip of the endodontic instrument. They may also have different shapes or orientations, capable of providing support to translationally lock the endodontic instrument 1 according to its longitudinal axis 10. For example, without going beyond the scope of the invention, they can be inclined with respect to a plane substantially transverse to the longitudinal axis 30.

These three flattened portions 121, together with the shoulders 124, constitute the essential surfaces of the assembly portion, which are intended to be in contact with the complementary jaws of an instrument-holding equipment. The contact between these flattened portions and the complementary jaws can simultaneously ensure that the longitudinal axis 10 of the endodontic instrument 1 is centered on the axis of rotation of the instrument-holding equipment, that the endodontic instrument 1 is rotated, and that the endodontic instrument 1 is translationally locked along its longitudinal axis 10, in the direction of its tip 110.

The translational locking of the endodontic instrument 1, along its longitudinal axis 10, in the direction of its assembly end 120 can be ensured, in the embodiment shown, by contact between this end 120 and a complementary surface of the instrument-holding equipment. In other embodiments, this locking can also be ensured by contact between the jaws of the instrument-holding equipment and shoulders of the instrument oriented toward the assembly end 120. For example, the flattened portions 121 can have such shoulders at their end closest to the tip 110. In the latter case, the flattened portions 121 of the assembly portion 12 and the shoulders 124 delimiting these flattened portions 121 ensure that the endodontic instrument 1 is held in place by the instrument-holding equipment.

As the endodontic instrument 1 is held in place by the instrument-holding equipment by the shape of the flattened portions 121, and optionally by the assembly end 120, the shape of the surface of the rest of the assembly portion 12 has no particular function for this assembly. Therefore, it is possible to imagine a plurality of shapes for this surface, other than the one shown in FIG. 1.

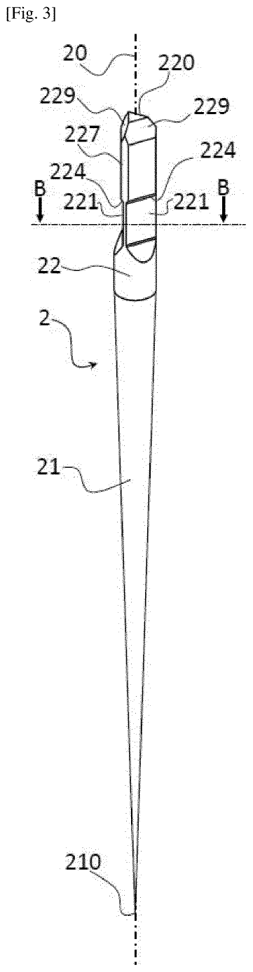

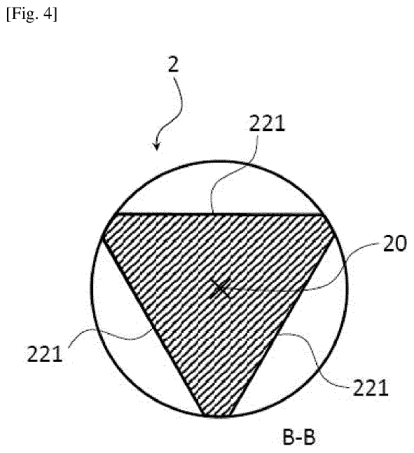

For example, FIG. 3 is a perspective view of an endodontic instrument 2 according to a variant of the embodiment shown in FIG. 1. This endodontic instrument 2 extends along a longitudinal axis 20, and comprises an active portion 21 extending up to a free end, or tip 210, and an assembly portion 22 extending up to an assembly end 220. At a locking segment, its assembly portion 22 has three flattened portions 221 the ends of which closest to the assembly end 220 of the instrument are delimited by shoulders 224 oriented toward the tip 210. As shown in the cross-sectional view of FIG. 4, the flattened portions 221 are positioned so as to be respectively complementary to the shape of the three sides of an equilateral triangle centered on the longitudinal axis 20, in a plane transverse to the longitudinal axis 20.

In this assembly portion 22, the end segment 227 of the assembly portion 22, which is located between the assembly end 220 and the flattened portions 221, does not have a cylindrical shape, but has a plurality of flattened portions parallel to the flattened portions 221. These flattened portions of the end segment 227 are, however, shallower than the flattened portions 221 used to hold the endodontic instrument 2, such that the shoulders 224 are clearly visible at the boundary between these flattened portions 221 and the end segment 227. The flattened portions formed on the surface of the end segment 227 of the assembly portion 22 have no function in holding the assembly portion 22 with the instrument-holding equipment. However, they can advantageously facilitate the insertion of the assembly portion 22 into the instrument-holding equipment by limiting the necessary spacing of the jaws, which will then be tightened against the flattened portions 221 to hold the assembly portion 22.

In addition, the segment of the assembly portion 22 immediately adjacent to the assembly end 220 has a chamfer formed by three inclined planes 229, which are, in this embodiment, produced by wire electrical discharge machining.

The distance between the flattened portions 121 used to hold the endodontic instrument and the longitudinal axis of the endodontic instrument is not necessarily dependent on the diameter of the endodontic instrument, or on the bar used to form the instrument. This makes it possible to form identical flattened portions at the same distance from the longitudinal axis of the endodontic instrument, on assembly portions made from cylindrical bars of different diameters. The identical shapes of the flattened portions means that the endodontic instruments obtained can be held by the jaws of the same instrument-holding equipment.

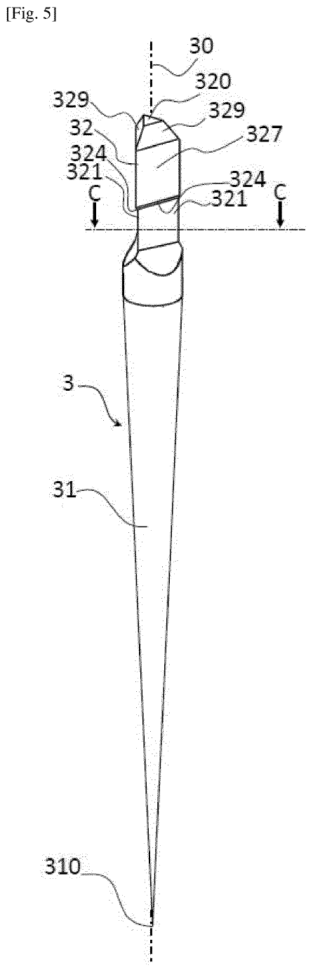

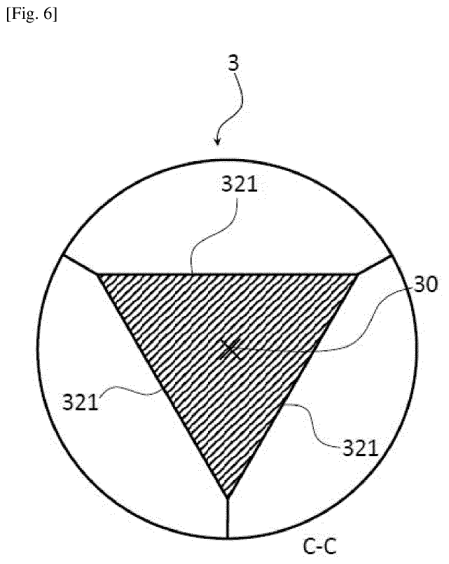

By way of example, FIG. 5 is a perspective view of an endodontic instrument 3 according to a variant of the embodiments shown in FIGS. 1 and 3. This endodontic instrument 3 extends along a longitudinal axis 30, and comprises an active portion 31 extending up to a free end, or tip 310, and an assembly portion 32 extending up to an assembly end 320. At a locking segment, its assembly portion 32 has three flattened portions 321 the ends of which closest to the assembly end 320 of the instrument are delimited by shoulders 324 oriented toward the tip 310. As shown in the cross-sectional view of FIG. 6, the flattened portions 321 are positioned so as to be respectively complementary to the shape of the three sides of an equilateral triangle centered on the longitudinal axis 30, in a plane transverse to the longitudinal axis 30.

The endodontic instrument 3 is formed from a cylindrical bar with a larger diameter than the cylindrical bar used to form the endodontic instruments 1 and 2. However, the flattened portions 321 are advantageously located at the same distance from the longitudinal axis 30 as the flattened portions 121 of the longitudinal axis 10, and the flattened portions 221 of the longitudinal axis 20. Furthermore, the end segment 327 of the assembly portion 32, which is located between the assembly end 320 and the flattened portions 321, advantageously has a shape close to the shape of the end segment 227 of the endodontic instrument 2. Similarly, the segment of the assembly portion 32 immediately adjacent to the assembly end 320 has a chamfer formed by three inclined planes 329, which are, in this embodiment, produced by wire electrical discharge machining.

The assembly portion 32 of this endodontic instrument 3 can thus advantageously be held by the same instrument-holding equipment as the holding portions of the endodontic instruments 1 and 2.

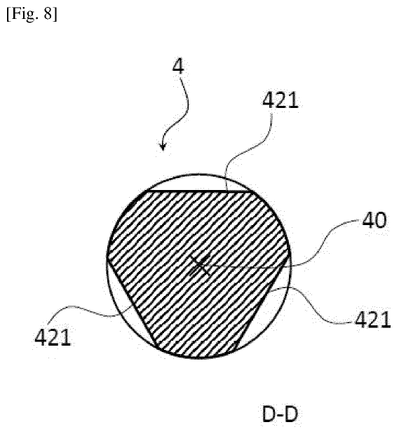

FIG. 5 is a perspective view of an endodontic instrument 4 according to a variant of the embodiments shown in FIGS. 1, 3 and 5. This endodontic instrument 4 extends along a longitudinal axis 40, and comprises an active portion 41 extending up to a free end, or tip 410, and an assembly portion 42 extending up to an assembly end 420. At a locking segment, its assembly portion 42 has three flattened portions 421 the ends of which closest to the assembly end 420 of the endodontic instrument 4, are delimited by shoulders 424 oriented toward the tip 410. As shown in the cross-sectional view of FIG. 8, the flattened portions 421 are positioned so as to be respectively complementary to the shape of the three sides of an equilateral triangle centered on the longitudinal axis 40, in a plane transverse to the longitudinal axis 40.

The endodontic instrument 4 is formed from a cylindrical bar with a smaller diameter than the cylindrical bar used to form the endodontic instruments 1 and 2. However, the flattened portions 421 are advantageously located at the same distance from the longitudinal axis 40 as the flattened portions 121 of the longitudinal axis 10, the flattened portions 221 of the longitudinal axis 20 and the flattened portions 321 of the longitudinal axis 30.

The assembly portion 42 of this endodontic instrument 4 can thus advantageously be held by the same instrument-holding equipment as the holding portions of the endodontic instruments 1, 2 and 3. The segment of this assembly portion 42 immediately adjacent to the assembly end 420 has a chamfer 429 that, in this embodiment, has a conical shape.

It should be noted that the flattened portions 421 occupy a smaller proportion of the perimeter of the assembly portion 42 than the flattened portions formed in bars of larger diameter. However, it has been observed that these relatively shallow flattened portions can be sufficient to hold and rotate endodontic instruments, with the desired torque.

In this way, endodontic instruments of different diameters, having flattened portions according to the invention, placed at the same distance from their longitudinal axis, can be held by the same instrument-holding equipment. The inventors have tested endodontic instruments made from bars of various diameters, ranging from 0.8 mm to 1.2 mm, corresponding to the diameters usually used in endodontics. Each of these endodontic instruments has three flattened portions, according to the invention, which are located 0.3 mm from the longitudinal axis of the instrument. Each of these instruments can be held by the jaws of the same instrument-holding equipment, cooperating with the flattened portions, and rotated by this equipment with sufficient torque to perform endodontic treatments.

Endodontic instruments according to the invention can advantageously consist solely of the blade obtained by machining this cylindrical metal bar, without the need to add other parts such as a handle. This facilitates the manufacture of the instrument.

In addition, manufacturing the assembly portion of these instruments only requires the machining of flattened portions, which are relatively easy to produce. This makes manufacturing particularly simple and inexpensive.

Furthermore, endodontic instruments according to the invention take up less space than endodontic instruments fitted with conventional handles. Therefore, they can be held by less cumbersome instrument-holding equipment in the patient's mouth.

Finally, as the flattened portions used to hold and rotate the endodontic instruments according to the invention can be formed in instruments of different diameters, a range of endodontic instruments of different diameters can easily be produced, which can be held and rotated by the same instrument holder.

The flattened portions formed in the assembly portion of the endodontic instruments according to the invention each form, for the purposes of the present invention, a surface forming a rectilinear segment in a plane transverse to the longitudinal axis of the endodontic instrument 1. In the embodiments shown, these flattened portions form flat surfaces parallel to the longitudinal axis.

However, in variants of the proposed solutions, the flattened portions may have different shapes. As such, by way of example, the distance between the flat flattened portions and the longitudinal axis can vary. In this case, the three flattened portions can be complementary to the surface of a regular three-sided pyramid.

It is also possible that the surface of the flattened portions is not flat. The surfaces of the flattened portions can be curved or corrugated, for example, or have a helical shape centered on the longitudinal axis, as long as they are complementary to the shape of an equilateral triangle centered on the longitudinal axis in a transverse plane.

However, the solution of flattened portions forming flat surfaces parallel to the longitudinal axis is preferred, as it is efficient and easy to implement.

In the embodiments shown, the locking segments of the assembly portions comprise three flattened portions that are complementary, in a transverse plane, to the shape of an equilateral triangle centered on the longitudinal axis of the endodontic instrument. This choice of three flattened portions, and only three, is a preferential choice that ensures ease of construction, good adaptation to a wide range of bar diameters, and efficient transfer of high torque.

However, some of the advantages of the invention can be achieved with a different number of flattened portions.

Thus, part of the advantages can be obtained with an endodontic instrument formed by machining a cylindrical rod, the axis of symmetry of which constitutes the longitudinal axis of said instrument, said endodontic instrument extending, along said longitudinal axis, between a first assembly end and a second free end, said endodontic instrument having an active portion, which extends from its free end, and an assembly portion, which extends from its assembly end, said assembly portion having a locking segment, at which four flattened portions are formed on the instrument, each of said four flattened portions being respectively complementary, in each of the cross-sections of this locking segment, to one of the sides of a square centered on the longitudinal axis of the instrument, at least one of said flattened portions being terminated, at the end thereof closest to the assembly end of the instrument, by a shoulder oriented substantially toward the free end of the endodontic instrument.

In the same way, part of the advantages can be obtained with an endodontic instrument formed by machining a cylindrical rod, the axis of symmetry of which constitutes the longitudinal axis of said instrument, said endodontic instrument extending, along said longitudinal axis, between a first assembly end and a second free end, said endodontic instrument having an active portion, which extends from its free end, and an assembly portion, which extends from its assembly end, said assembly portion having a locking segment, at which five flattened portions are formed on the instrument, each of said four flattened portions being respectively complementary, in each of the cross-sections of this locking segment, to one of the sides of a regular pentagon centered on the longitudinal axis of the instrument, at least one of said flattened portions being terminated, at the end thereof closest to the assembly end of the instrument, by a shoulder oriented substantially toward the free end of the endodontic instrument.

Finally, part of the advantages can also be obtained with an endodontic instrument formed by machining a cylindrical rod, the axis of symmetry of which constitutes the longitudinal axis of said instrument, said endodontic instrument extending, along said longitudinal axis, between a first assembly end and a second free end, said endodontic instrument having an active portion, which extends from its free end, and an assembly portion, which extends from its assembly end, said assembly portion having a locking segment, at which six flattened portions are formed on the instrument, each of said four flattened portions being respectively complementary, in each of the cross-sections of this locking segment, to one of the sides of a regular hexagon centered on the longitudinal axis of the instrument, at least one of said flattened portions being terminated, at the end thereof closest to the assembly end of the instrument, by a shoulder oriented substantially toward the free end of the endodontic instrument.

However, such variants are more difficult to implement than the preferred three-flattened portion solution, and may be less effective at transmitting torque.

In the embodiments shown, each of the three flattened portions of the locking segment is terminated, at the end thereof closest to the assembly end of the instrument, by a flattened portion oriented substantially toward the free end of the endodontic instrument.

However, it should be noted that it is not necessary for each of these flattened portions to have such a shoulder. In fact, a single shoulder may suffice to allow a jaw of an instrument holder, complementary in shape to the flattened portions, to translationally lock the instrument along its longitudinal axis, in the direction of its tip. Therefore, it is possible for one or two of the flattened portions to have no such shoulder and, for example, to extend up to the assembly end of the endodontic instrument.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1.-7. (canceled)

8. An endodontic instrument extending along a longitudinal axis between a first assembly end and a second free end, said endodontic instrument having an active portion which extends from the second free end, and an assembly portion which extends from the first assembly end,
wherein said assembly portion has a locking segment, at which three flattened portions are formed on the instrument,
each of said three flattened portions being respectively complementary, in each cross sections of said locking segment, to a side of an equilateral triangle centered on said longitudinal axis,
at least one of said flattened portions being terminate, at an end thereof closest to said first assembly end, by a shoulder oriented toward said second free end of said endodontic instrument.

9. The endodontic instrument according to claim 8, wherein said endodontic instrument is formed by machining a cylindrical rod with an axis of symmetry which constitutes said longitudinal axis.

10. The endodontic instrument according to claim 8, wherein each of said three flattened portions is terminated, at respective ends thereof closest to the second free end of the endodontic instrument, by a shoulder oriented toward the first assembly end of the endodontic instrument.

11. The endodontic instrument according to claim 8, wherein each of said three flattened portions forms a flat surface.

12. The endodontic instrument according to claim 11, wherein the flat surface of each of said three flattened portions is parallel to said longitudinal axis.

13. The endodontic instrument according to claim 12, wherein each of said flattened portions is located at a distance from said longitudinal axis of between 0.25 mm and 0.35 mm, and
wherein said endodontic instrument is formed by machining a cylindrical rod having a diameter between 0.8 mm and 1.2 mm.

14. The endodontic instrument according to claim 13, wherein said assembly portion has an end segment, between said assembly end and said locking segment, said end segment having three flattened portions, respectively parallel to the three flattened portions of said locking segment, and located at a greater distance from said longitudinal axis than said flattened portions of said locking segment.
